(19) United States
(12) Patent Application Publication
(10) Pub. No.: US 2002/0062839 A1
(43) Pub. Date: May 30, 2002

(54) Method and apparatus for frontside and backside wet processing of a wafer

(76) Inventors: Steven Verhaverbeke, San Francisco, CA (US); J. Kelly Truman, Morgan Hill, CA (US)

Correspondence Address: Michael A. Bernadicou, APPLIED MATERIALS, INC., Patent Counsel, Legal Affairs Department, P.O. Box 450A, Santa Clara, CA, 95052, US

(21) Appl. No.: 09/891,890

(22) Filed: Jun. 25, 2001

Related U.S. Application Data
(60) Provisional application No. 60/214,057, filed on Jun. 26, 2000.

(51) Int. Cl. B08B 7/04

(52) U.S. Cl. 134/1.3; 134/6; 134/36

(57) ABSTRACT

A method and apparatus for processing a wafer is described. According to the present invention a wafer is placed on a substrate support. A liquid is then fed through a conduit having an output opening over the wafer. A gas is dissolved in the liquid prior to the liquid reaching the output over the wafer by flowing a gas into the conduit through a venturi opening formed in the conduit. The liquid with dissolved gas is then fed through the opening and onto the wafer where it can be used to etch, clean, or rinse a wafer.

This application claims the benefit of provisional application Ser. No. 60/214,057 filed Jun. 26, 2000 entitled METHOD AND APPARATUS FOR FRONTSIDE AND BACKSIDE WET PROCESSING OF A WAFER.

### BACKGROUND OF THE INVENTION

1. Field of the Invention

The present invention relates to the field of relations to the field of semiconductor processing and more specifically to a method and apparatus for simultaneously cleaning the frontside and backside of a wafer in a single wafer process.

2. Discussion of Related Art

Wet etching and wet cleaning of silicon wafers is usually done by immersing the wafers into a liquid. This can also be done by spraying a liquid onto a wafer or batch of wafers. Wet wafer cleaning and etching is traditionally done in a batch mode. Because of the need for shorter cycle times in chip manufacturing, there is a need for fast single wafer processing.

When using fast single wafer processing, fast and efficient processing is very important. A batch mode reactor will etch and clean wafers in typically 60 minutes for a full HF-SC1-SC2 cycle. However, since wet cleaning takes up to 30% of the processing steps in a typical semiconductor manufacturing flow, there is a need for shorter cycle cleaning process. A shorter cycle will reduce the overall fab cycle time. The shortest overall fab cycle time can be achieved with a single wafer processing tool. Therefore, there is a need for a fast single wafer processing. When replacing batch wet cleaning with a single wafer cleaning, the processing tool has to be optimized so as to achieve the shortest possible processing time. Therefore, every parameter, whether being a process or a design parameter, has to be geared to fast processing. As industry migrates to 300 mm wafers, both sides of the wafer are polished and both side of the wafer needs to be cleaned efficiently for particles. This is because the backside particles can adversely effect the focus of the lithography exposure steps in the steppers.

Unfortunately, none of the current state of the art solutions provide a solution which satisfies the requirement for fast single wafer cleaning. The current technology of choice for cleaning front and backside of particles with topography on the frontside is batch type wet bench. However, the cycle time is very long for such processes.

Thus, what is needed is a method and apparatus which is efficient in particle removal on both the frontside and backside in a short cycle time. In order for single wafer tool to be utilized without penalty and overall production cost is for the single wafer tool to be able to accomplish in roughly 2 minutes what a batch tool performs in 60 minutes.

### SUMMARY OF THE INVENTION

A method and apparatus for simultaneously wet processing the frontside and backside of a wafer. According to the present invention a first liquid is applied to a first side of a wafer having active features thereon. Acoustic waves are applied to the first solution on the first side of the wafer. A second solution is applied to the second side of the wafer which is opposite the first side. The second side of the wafer is scrubbed with a brush while acoustic waves are applied to the first side of the wafer.

### BRIEF DESCRIPTION OF THE DRAWINGS

FIG. 1a is an illustration of a cross-sectional view of a wet processing apparatus which can process the front and backside of a wafer simultaneously in accordance with the present invention.

FIG. 1b is an illustration of an overhead view of the wet processing apparatus shown in FIG. 1a.

FIG. 2a is an illustration of a side view of a wafer support and an acoustic transducer.

FIG. 2b is an illustration of a top view of the wafer support and brush.

FIG. 3 is an illustration of a side view of a wafer support and megasonic transducer plate.

### DETAILED DESCRIPTION OF THE PRESENT INVENTION

The present invention is a novel method and apparatus for simultaneously cleaning the frontside and backside of a wafer. In the following description numerous specific details are set forth in order to provide a thorough understanding of the present invention. One of ordinary skill in the art will understand that these specific details are for illustrative purposes only and are not intended to limit the scope of the present invention. Additionally, in other instances, well-known processing techniques and equipment have not been set forth in particular detail in order to not unnecessarily obscure the present invention.

The present invention is a novel method and apparatus for simultaneously cleaning the frontside and backside of a wafer. According to the present invention a first cleaning solution is applied to a wafer frontside having features or devices thereon. While apply the cleaning solution to the frontside sonic or acoustic waves are applied to the frontside of the wafer to help remove particles from the feature side surface with a topography. Additionally, while the first fluid and sonic waves are applied to the frontside, a second liquid which may or may not be the same as the first liquid is applied to the wafer backside and a brush rotated against the wafer backside to remove particles from the backside with brush scrubbing. The present invention provides a fast single wafer processing by utilizing sonic waves to remove particles on the side of the wafer having a topography and using brush scrubbing to remove particles from the side of the wafer having a flat surface. The present invention can provide fast and efficient front and backside particle removal.

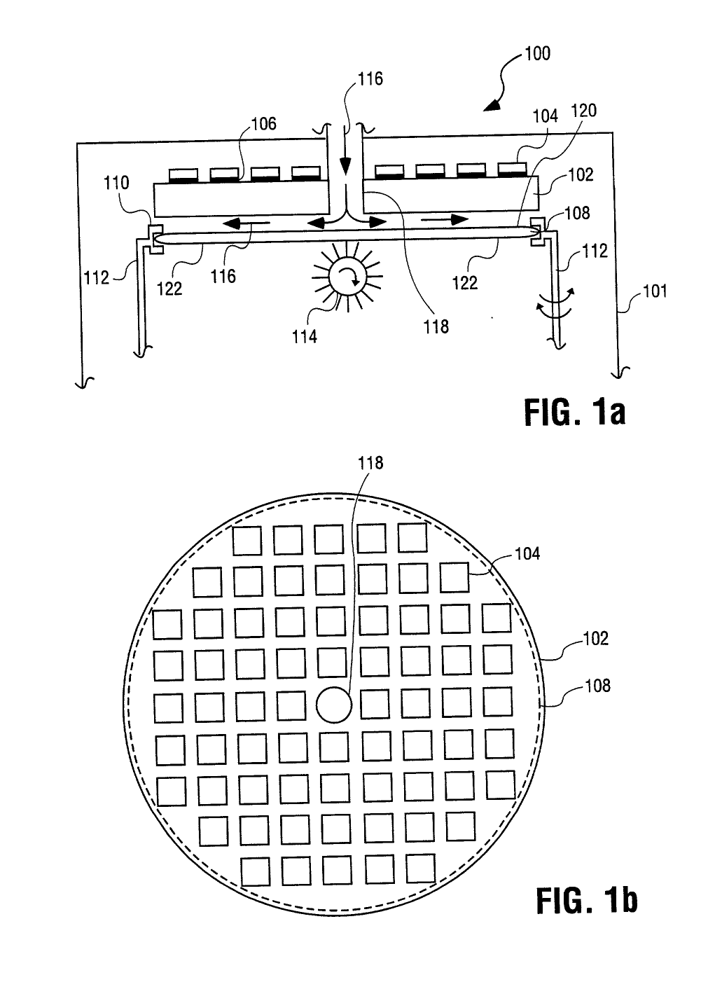

An example of a cleaning apparatus in accordance with the present invention is apparatus 100 illustrated in FIG. 1. Single wafer cleaning apparatus 100 shown in FIG. 1 includes a plate 102 with a plurality of acoustic or sonic transducers 104 located thereon. Plate 102 is preferably made of aluminum but can be formed from other materials such as stainless steal on sapphire. The plate 102 is preferably coated with a corrosion resistant flouropolymor such as Halar. The transducers 104 are attached to the top surface of plate 102 by an epoxy 106. The transducers 104 cover the entire top surface of plate 102 as shown in FIG. 1b. Additionally, as also shown in FIG. 1b the transducer covered plate 102 has substantially the same shape as a wafer 108 which is being processed and covers the entire surface area of wafer 108. Transducers 104 preferably generates sonic waves in the frequency range between 400 kHz and 8 MHz. In an embodiment of the present invention the transducers 104 are piezoelectric devices. The transducers 104 create acoustic or sonic waves in a direction perpendicular to the surface of wafer 108.

A substrate or wafer 108 such as silicon wafer is held a distance of about 3 mm from the bottom surface of plate 102. The wafer 108 is clamped by a plurality of clamps 110 to a wafer support 112 which can rotate wafer 108 about its central axis. The wafer support can rotate or spin wafer 108 about its central axis at a rate between 0-6000 rpms. In apparatus 100 only the wafer support 112 and wafer 108 are rotated during use whereas plate 102 remains in a fixed position. In an embodiment of the present invention wafer 112 can rotate a wafer about its central axis in both a clockwise and counter clockwise fashion.

In use, wafer 108 is clamped to wafer support 112 by clamps 110. In the preferred method of the present invention wafer 108 is clamped to support 112 so that the wafer frontside 120, located on which topography creating device features such as transistors, capacitors, and interconnects face towards plate 102 and the backside which is generally featureless and therefore flat faces towards brush 114. Except for the initial wafer clean and cleanings after CMP (Chemical Mechanical Polishing) the wafer frontside will contain some type of topography.

In use, a first liquid 116 is fed through an opening 118 in plate 102 and fills the gap between plate 102 and wafer 108. First or frontside liquid 116 can be simply water such as DI water or a cleaning solution such as NH₄OH or a mixture of NH₄OH and H₂O₂ and H₂O (also known as SC1). While flowing liquid 116 between plate 102 and wafer top surface 120 transducers 104 are activated to apply sonic or acoustic waves into liquid 116. Applying sonic waves to fluid 120 enhances particle removal from a surface having a topography.

Additionally, while applying first liquid 116 and acoustic waves to the frontside of wafer 108, a second liquid is applied to the wafer backside 122 while brush 114 is rotated and scrubs wafer backside 122. The second or backside liquid can be the same as or different than the frontside liquid 116. For example, backside liquid can be simply water such as DI water or can be cleaning solutions such as NH₄OH or a mixture of NH₄OH and H₂O₂ and H₂O (also known as SC1). The backside liquid can be applied to the backside 122 of wafer 108 by for example, spraying backside 122 with backside liquid or applying backside liquid through brush 114.

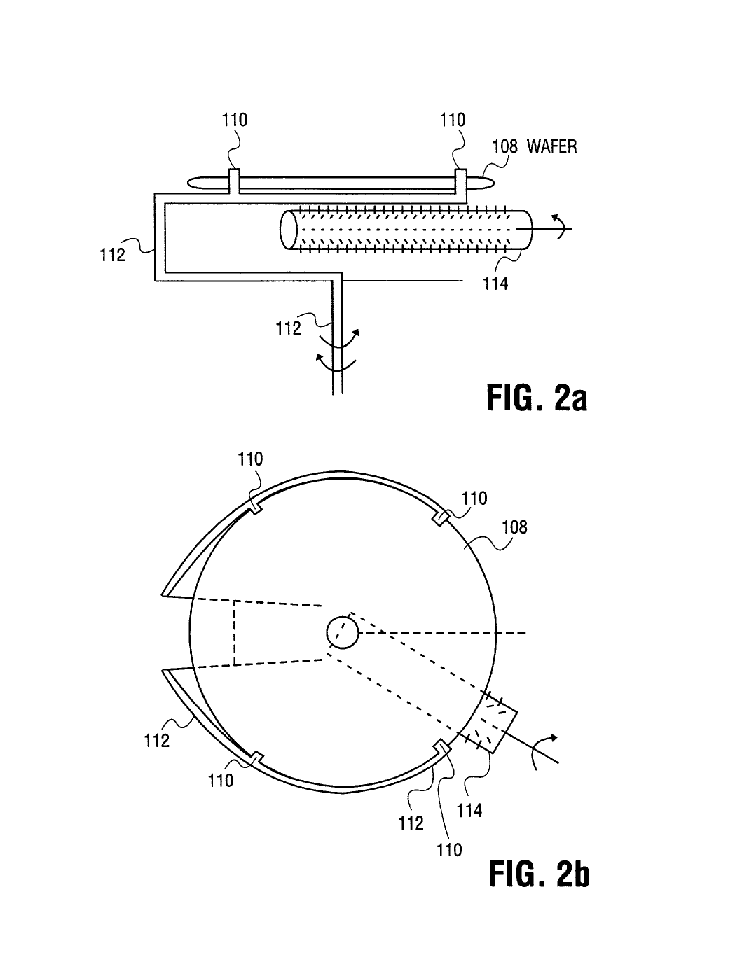

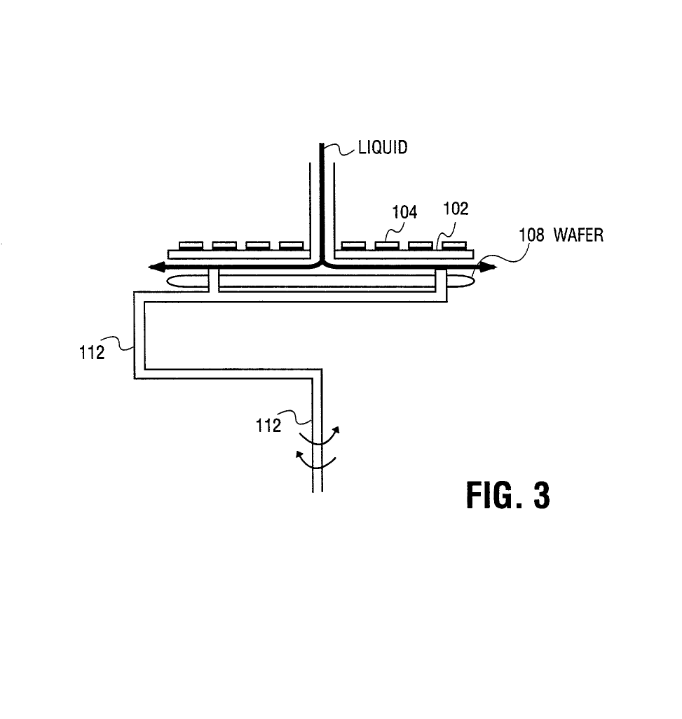

According to the present invention wafer support device 112 is designed specifically to accommodate different cleaning operations on both sides of the wafer. In an embodiment of the present invention wafer support 112 holds the wafer on the edges with clamps 110. Wafer support 112 allows the transducer plate 102 to be placed on the frontside of the wafer and the brush on the backside of the wafer. An example of a suitable substrate support 112 is shown in FIG. 2a, FIG. 2b, and FIG. 3. In FIG. 2a and FIG. 2b only the wafer support 112 and the backside brush 114 are shown. In FIG. 3, the wafer support 112 and the transducer plate 102 on the frontside of the wafer are shown. Utilizing wafer support 112 the wafer rotates almost 360° in one direction and then reverts the direction and rotates again almost 360° in the other direction. At the end of the backside cleaning the brush can retract and then the wafer can be rotated more than a full turn in one direction. During the cleaning action the back and forth rotation is not a problem due to the low rotation rates (between 10-100 rpms) necessary during cleaning. However, during rinsing and drying the wafer has to rotate at high rotation speeds. During rinsing and drying the brush can be retracted and the wafer rotated in one direction at a high rotation speed of about 3000 rpms until the wafer is sufficiently rinsed and spun dry.

Thus, a novel method and apparatus for cleaning the frontside and backside of a wafer simultaneously in a single wafer apparatus has been described. It is to be appreciated that the present invention has been described with respect to a specific preferred embodiment and it is expected that one of ordinary skill in the art will be able substitute or eliminate features of the present invention and still be within the scope of the present invention. For example, although the preferred embodiment of the present invention utilizes plate 102 and transducer 104 to generate sonic waves, other means for generating sonic waves such as a quartz rod having a transducer thereon and where the liquid 116 builds up between the rod and the top surface of the wafer 120 can be used. Similarly, although a single brush is shown, it is expected that multiple brushes can be used if desired. Similarly, it is conceivable that processing apparatus 100 can be flipped wherein the transducer plate 102 is located on the bottom facing a wafer placed face down on support 112 and brush 114 is on the top facing the backside of the wafer facing up.

We claim:

1. A method of wet processing a wafer comprising:
applying a first liquid to a first side of a wafer having a topography thereon;
applying acoustic waves to said first liquid on said wafer first side;
applying the second liquid to said second side of said wafer, said second side opposite said first side; and
brushing said second side of said wafer while applying said acoustic waves to said first liquid on said first side and said second liquid to said second side.

2. The method of claim 1 further comprising rotating said wafer while applying said acoustic waves and brushing said wafer.

3. The method of claim 1 wherein said first liquid is the same as said second solution.

4. The method of claim 1 wherein said first liquid is different than said second solution.

5. The method of claim 1 wherein said first liquid consists of H₂O.

6. The method of claim 1 wherein said first liquid comprises NH₄OH.

7. The method of claim 6 wherein said first liquid further comprises H₂O₂.

8. The method of claim 1 wherein said second liquid consists of H₂O.

9. The method of claim 1 wherein said second liquid comprises NH₄OH.

10. The method of claim 9 wherein said second liquid further comprises H₂O₂.

11. The method of claim 1 wherein said first liquid comprises NH₄OH and H₂O₂ and wherein said second liquid consists of H₂O.

12. A single wafer wet processing apparatus comprising:
a wafer support for holding a wafer to be processed in a wafer processing area;
means for applying sonic waves to a wafer located on said wafer support, said means for applying sonic waves positioned on a first side of said wafer processing area; and
a brush for scrubbing a wafer positioned on a second side of said wafer processing area opposite said first side.

13. The apparatus of claim 12 wherein said means for applying sonic waves comprises a plate having a plurality of transducers located thereon.

14. The apparatus of claim 12 wherein said means for applying sonic waves comprises a rode having a transducer located thereon.

15. The apparatus of claim 12 wherein said wafer support rotates a wafer located thereon about the wafers central axis.

16. The apparatus of claim 15 wherein said wafer support can rotate in a clockwise and a counter clockwise direction.
